(19) United States
(12) Patent Application Publication
(10) Pub. No.: US 2025/0225428 A1
(43) Pub. Date: Jul. 10, 2025

(54) Content Generation With Machine Learning-Augmented Summarization

(71) Applicant: Oracle International Corporation, Redwood Shores, CA (US)

(72) Inventors: Kenneth Joseph Meltsner, Portland, OR (US); Kent Arthur Spaulding, Portland, OR (US)

(73) Assignee: Oracle International Corporation, Redwood Shores, CA (US)

(21) Appl. No.: 18/405,935

(22) Filed: Jan. 5, 2024

(51) Int. Cl. G06N 20/00

(52) U.S. Cl. CPC G06N 20/00

(57) ABSTRACT

Techniques are described herein that provide machine learning-augmented report summarization. One or more embodiments train and apply a machine learning model to generate a summary report for an entity that is associated with a particular hierarchical level in an organization utilizing base reports from entities at another hierarchical level in the organization. A training data set used for training the machine learning model includes base reports at a particular hierarchical level in the organization and identification of content from the base reports that is to be used for generating a summary report. The machine learning model may then be applied to any set of base reports to generate a corresponding summary report.

### TECHNICAL FIELD

The present disclosure relates to generating summary reports from a set of content. In particular, the present disclosure relates to applying a trained machine learning model to a set of data including base reports to identify a set of content to include in a summary report.

### BACKGROUND

In the current landscape of organizational reporting, many organizations use periodic (e.g., daily, weekly, or monthly) reports based on the hierarchical nature of the organization. For example, individuals within the organization may prepare weekly reports on accomplishments and challenges for their manager. The manager then assembles a single report for their manager based on those reports selecting or summarizing details from the individual reports in the process. In turn, that manager may produce a similar report for their manager. Generating summary reports from extensive base reports often involves significant manual effort and time-consuming processes. When preparing reports, managers typically make some effort to reduce the volume of reported information.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for providing ML-augmented report summarization in accordance with one or more embodiments;

FIG. 3 illustrates an example set of operations for training a machine learning model to provide ML-augmented report summarization in accordance with one or more embodiments.

FIG. 4 illustrates an example embodiment of a system for generating a summary report using an ML model in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. BASE REPORT SUMMARIZATION SYSTEM OVERVIEW
3. MACHINE LEARNING-AUGMENTED REPORT SUMMARIZATION
4. MACHINE LEARNING MODEL TRAINING
5. EXAMPLE EMBODIMENT FOR GENERATING A SUMMARY REPORT USING A MACHINE LEARNING MODEL
6. HARDWARE OVERVIEW
7. MISCELLANEOUS; EXTENSIONS

### 1. General Overview

One or more embodiments train and apply a machine learning (“ML”) model to generate a summary report for an entity that is associated with a particular hierarchical level in an organization using base reports from entities at another hierarchical level in the organization. A training data set for training the ML model includes base reports at a particular hierarchical level in the organization and identification of content from the base reports that is to be used for generating a summary report. The ML model may then be applied to any set of base reports to generate a corresponding summary report. Furthermore, the ML model may be iteratively applied to generate new summary reports from previously generated summary reports.

For example, a system may apply an ML model to generate a report for a team manager in a first hierarchical level of an organization that includes a performance metrics for a set of team members. The ML model identifies content from a data set and/or reports generated by the low-level employees to include in the team manager's report. The system then applies the ML model to a set of reports from multiple different team managers to generate a report for a vice president at a second hierarchal level of the organization. The ML model identifies content from the first-level reports to include in the VP's report. For example, the VP's report may summarize the performance of a set of ten teams in the organization. The report may include performance metrics trends for the organization. While the reports for the managers may include operations performed by team members and team member performance statistics, the report for the vice president may include efficiency trends over time for the combined set of all the teams in the organization.

One or more embodiments apply a set of ML models to raw data and generated reports to generate additional reports. For example, a set of team members may generate reports about tasks performed and success rates for the tasks from raw data. A data classification ML model identifies from the first-level reports content that should be included in second-level reports as well as content that should be omitted from the second-level reports. In one embodiment, a clustering-type ML model generates clusters from embeddings of data components in the first-level reports to identify data components that meet a similarity threshold even though they may be described using different words. For example, one team member may describe a project as a Vanilla project. Another may describe the project as a user interface (“UI”)-optimized project. The clustering-type ML model may cluster the two data components together based at least on context from the reports and/or the raw data. The data classification ML model may further classify the two data components with the same classification for inclusion in a second-level report. Based on classifying two different sets of text with the same identifier, the system generates a summary report using content associated with the two different sets of text. For example, one base report may describe a set of problems encountered by a programmer trying to add functionality to an application referred to as Application1. Another base report may describe a set of successes by another programmer adding functionality to an application referred to as ApplicationA. A machine learning model clusters Application1 and ApplicationA in the same cluster. Accordingly, the system identifies the different names as corresponding to the same application. The system generates a summary report describing the progress of Application1. The system includes in the summary report a summary of the problems identified by the former programmer and the successes identified by the latter programmer. Thus, despite the different names Application1 and ApplicationA, the ML model identifies these references as the same application, and consolidates the references into a single reference, Application1.

Upon identifying content to include in a second-level report, the system may apply a generative artificial intelligence (hereinafter “AI”) ML model to the data to generate the second-level report including one or more of natural language, charts, graphs, and pictures. The generative AI machine learning model may be trained to generate reports that include different types of data for different hierarchical level entities. For example, the generative AI model may generate a report for a team manager that includes team member performance metrics and descriptions of tasks completed. The generative AI model may generate a report for a vice president that summarizes a set of manager reports and identifies performance trends across multiple teams over time.

One or more embodiments train the data classification ML model to identify content associated with particular hierarchical levels. For example, when a team member generates a report describing tasks performed in a given week, the ML model may identify one data component, such as a description of progress made to complete a particular project, as corresponding to a third hierarchical tier. The system may include the data component in both a report to a manager and a report to a vice president who oversees multiple managers. In contrast, the data classification ML model may identify another data component as corresponding to a second level. The system may include the data component in a report to a manager and may refrain from including the data component in a report to the vice president.

The system may perform one or more operations on the data component prior to including the data component in a second-level report. For example, the system may summarize the data component from one or more first-level reports, calculate a sum or average of values associated with the data component (or may perform any other mathematical function on the data), generate a graph from the data component, generate a hyperlink to raw data associated with the data component, calculate performance metrics from the data component, and calculate trends over time from the data component.

One or more embodiments described in this Specification and/or recited in the claims may not be included in this General Overview section.

### 2. Base Report Summarization System Overview

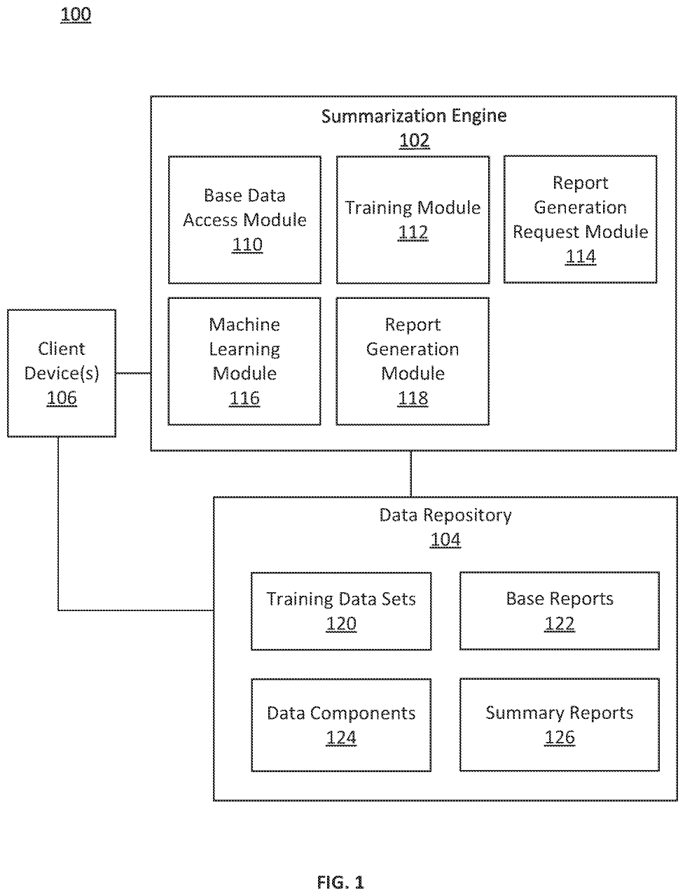

FIG. 1 illustrates a system 100 in accordance with one or more embodiments. As illustrated in FIG. 1, the system 100 includes a summarization engine 102, a data repository 104, and client device(s) 106. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

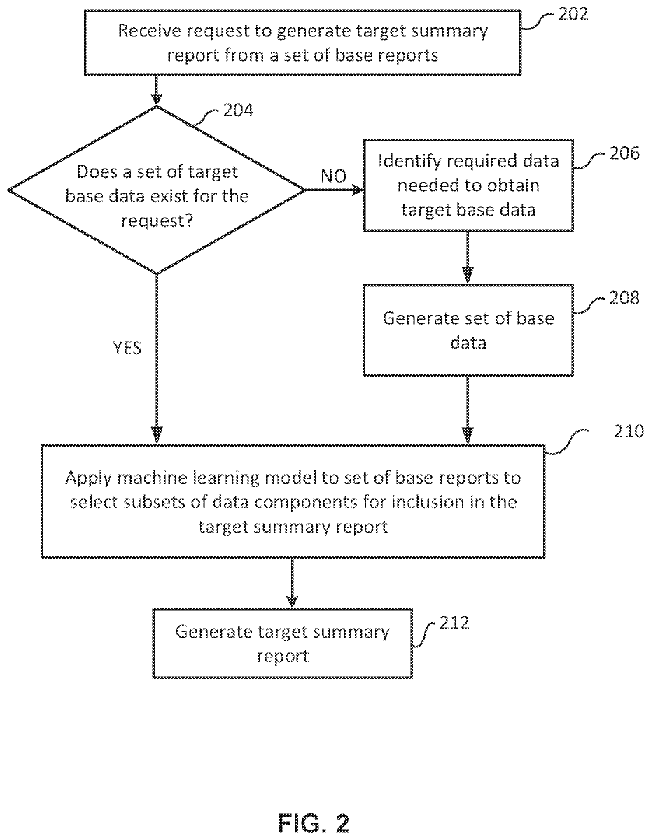

In one or more embodiments, the summarization engine 102 refers to hardware and/or software configured to perform operations described herein for providing ML-augmented report summarization. Examples of operations for providing ML-augmented report summarization are described below with reference to FIG. 2.

In one or more embodiments, the summarization engine 102 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the system 100 includes a summarization engine 102, a data repository 104, and one or more client devices 106. The summarization engine 102 includes a base data access module 110, a training module 112, a report generation request module 114, an ML module 116, and a report generation module 118.

In one or more embodiments, the base data access module 110 collects sets of base data. Base data includes, for example, reports generated by users or employees and data generated by a system that may be used in reports. For example, one set of base data includes a set of reports generated by team leaders of three different teams. The team leaders access data including work logs to identify the work their team performed during a particular time period. Another set of base data includes system performance data. The team leaders may not have included the system performance data in their reports. The base data access module 110 accesses the performance data that was not previously included in any generated reports. According to yet another example, a user may generate a report that refers to a set of data. For example, the user may summarize a project and provide a link to a stored set of data. The system may access the data stored at the location indicated by the link.

The training module 112 trains the ML model using a machine learning algorithm. The ML model is the output of a machine learning algorithm. In one or more embodiments, a machine learning algorithm is an algorithm that can be iterated to train a target model f that best maps a set of input variables to an output variable.

A machine learning algorithm is an algorithm that can be iterated to train a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The training module 112 accesses raw data and generates training datasets from the raw data. The raw data is sourced from one or more sources within an organization. For example, raw data may include content from base reports, such as reports generated by employees to report on a task or project. In addition, or in the alternative, base reports may be used to access raw data. For example, the base reports may include links to data sources that store log data or system telemetry data. According to another example, the system may obtain raw data from external data sources, such as data storage devices that store system data, performance metrics corresponding to system devices, processes, or applications, customer feedback, financial records, or market analyses. The training module 112 generates training datasets from the raw data by identifying segments or components of raw data to include in summary reports at one or more hierarchal levels in an organization.

In one or more embodiments, the datasets each include a particular base report containing a set of data components. In one or more embodiments, the training data may also include labels or other identifiers that identify subsets of data components to be included in particular summary reports. The training data enables the ML model to learn correlations among data components. The training data further enables the ML model to learn correlations between particular data components and particular summary reports. The training module 112 adjusts parameters of a machine learning model being trained on the training datasets.to improve the ability of the ML model to determine which data components to include in one or more summarization reports.

The report generation request module 114 receives a request to generate a summary report from a set of base reports. In one or more embodiments, these requests may be initiated by users. For example, a user may interact with a graphical user interface (GUI) to request a report. In addition, or in the alternative, the request may be initiated by an automated process. For example, a system may be configured to generate a summary report from a set of base reports at regular intervals of time, such as weekly or monthly. The system generates the request without human intervention. In one or more embodiments, the request includes one or more parameters that specify base reports to be used in the summary report. In one example, a user might trigger a request to compile a summary report from a collection of base reports generated within a specific timeframe or related to a particular organizational unit.

Upon receiving the request, the report generation request module 114 collates data from the set of base reports for inclusion in the summary report. In one or more embodiments, this set of base reports includes a range of base reports, each providing insights into the organization and activities derived from the outputs of the ML models. In one or more embodiments, the base reports include details pertaining to individual responsibilities, access permissions, and established roles within the organization.

The ML module 116 applies the ML model to select data components from the set of base reports to include in the summary report. The ML module makes use of its training to identify and extract relevant information from the base reports for inclusion in the summary report.

The report generation module 118 generates a summary report that includes the selected data components from the base reports. In one or more embodiments, the summary report is a natural language summary report that is generated to be human-comprehensible. In one or more embodiments, at least some of the information from the selected data components may be presented as visual data, such as charts or graphs.

The functions of these modules will be further discussed below with respect to FIG. 2.

In one or more embodiments, a data repository 104 is any type of storage unit and/or device (e.g., a file system, database, collection of tables, or any other storage mechanism) for storing data. Further, a data repository 104 may include multiple different storage units and/or devices. The multiple different storage units and/or devices may or may not be of the same type or located at the same physical site. Further, the data repository 104 may be implemented or executed on the same computing system as the summarization engine 102. Alternatively, or in addition, a data repository 104 may be implemented or executed on a computing system separate from the summarization engine 102. The data repository 104 may be communicatively coupled to the summarization engine 102 and the client device(s) 106 via a direct connection or via a network.

Information describing the training data sets 120, the base reports 122, the data components 124, and the summary reports 126 may be implemented across any of components within the system 100. However, this information is illustrated within the data repository 104 for purposes of clarity and explanation.

The training sets 120 are curated sets of information prepared for instructing and refining the ML model. These training sets include a base report and a set of identification labels. The base report includes data components. Examples of data components include, e.g., customer feedback scores, response times, issue resolution details, and financial metrics. The identification labels specify whether particular data components should be included in generated reports. The identification labels may specify hierarchal levels associated with the reports. For example, one data component in a report may be associated with a label corresponding to the highest hierarchal level. The component may be included in a report to a chief executive officer (CEO) of a company. Another data component in the same report may be associated with a label corresponding to a lower hierarchal level. The data component may be included in a report to a supervisor. The data component may be omitted from reports at higher hierarchal levels, such as division chiefs, vice-presidents, and the CEO.

The base reports 122 represent reports from entities at a particular, different hierarchical level in the organization. In one or more embodiments, the base reports are used to generate additional reports for higher hierarchical levels. For example, a supervisor's summary report may be a base report for a division head's summary report. In one or more embodiments, these base reports encapsulate a specific set of information relevant to a given context or domain, ranging from individual contributions to higher-level team or departmental activities. A “context” here may refer to specific circumstances, environments, or focal points within which the information in the base reports is situated. Examples include project-specific details, operational performance, or customer service interactions. A “domain” here refers to a broader field or area to which the base reports relate. Examples include software development, organizational performance, or customer relations. The system applies the machine learning model to a set of base reports to select subsets of data from the base reports and other raw data to include in summary reports.

In one or more embodiments, some base reports may be generated as a result of user actions within the system. For example, when users interact with the platform, the system captures their selections, preferences, and interactions. Base reports are then generated to reflect these pieces of information about the user. In one or more embodiments, some base reports may be user-generated, where individual contributors or managers manually compile information relevant to their activities, preferences, or specific hierarchical levels. In one or more embodiments, base reports may be generated from other existing reports. For example, an ML model may be applied to selectively extract and integrate information from other existing reports to generate the base reports. In one or more embodiments, base reports may be generated for different hierarchical levels. For example, different base reports corresponding to individual contributors, team leaders, department heads, and executives may be generated. These base reports could include data components relevant to specific levels of the organizational hierarchy.

The data components 124 refer to discrete segments of textual and graphical context within the base reports that hold semantic meaning separate from other segments of textual and graphical content. Examples of data components include words, phrases, sentences, numbers, equations, diagrams, and pictures. Examples of types of data components include reports of errors identified in a software development process, descriptions of project milestone statuses, customer feedback logs, quantitative metrics on task completion times, and summaries of team collaboration activities. The data components include specific pieces of information, ranging from textual descriptions of work items to quantitative metrics or references to external data sources. Examples of data components include individual bug reports of bugs or errors identified in a software development process, descriptions of the status of project milestones, customer names, performance metrics of employees, teams, and computing systems, detailed logs of software testing outcomes, financial data related to project expenditures, survey responses regarding user satisfaction, timestamps of key project events, textual summaries of team meetings, and any other distinct pieces of information relevant to the organizational context.

The summary reports 126 refer to condensed and organized representations of information derived from a set of base reports and from raw data. In one or more embodiments, these reports are generated in response to specific requests. For example, a user may interact with a graphical user interface (GUI) to request a summary report from a set of teams working on a particular project. In one or more embodiments, the summary reports may be generated in natural language intended to be read by humans. In addition, or in the alternative, the reports may be generated in some other form, such as in computer-readable language. A summary report generated in a computer-readable form may be used to generate notifications or alerts regarding employee performance, without necessarily generating a text report from the employee. In one or more embodiments, summary reports may include distilled insights from a large volume of detailed data. Summary reports are tailored to provide a higher-level overview than the base data from which the summary report is generated. The summary reports capture key data components which have been identified as “key” by the ML model during the application of patterns learned during training of the ML model.

A description of one example summary report follows. Part 1 of this summary report relates to Team Performance. Distilling information from multiple base reports, the summary report includes information that Team A handled 20 customer calls, with 80% of the calls reaching a resolution and with 90% of the calls having the user report that they were satisfied. Meanwhile, Team B handled 30 customer calls, with 90% of the calls reaching a resolution and with 70% of the calls having the user report that they were satisfied. Part 2 of the summary report relates to Trends. Taking information from raw data sourced from different organizational sources, the report states that the average call time of Team A was 5 minutes, and the average call time of Team B was 3 minutes. The report also includes trend graphs, with the first showing increasing call times for Team A, and the second showing decreasing call times for Team B. Part 3 of the summary report relates to a Team Member Highlight. Data from a specific team member's base report is included in a team leader report: “Customer X called to complain about System Y. The customer was very angry. I was able to resolve the issue to customer's satisfaction, and even convinced the customer to upgrade to Feature Z.” According to one or more embodiments, a system trains a machine learning model to identify (a) summarized data from base reports that worded differently than the data in the base reports, (b) raw data that was not included in base reports, and (c) excerpts from a particular base that uses the wording from the base report. The system trains the ML model to identify different examples and combinations of (a), (b), and (c) to be included in reports associated with different hierarchal levels in an organization.

### 3. Machine Learning-Augmented Report Summarization

FIG. 2 illustrates an example set of operations for providing ML-augmented report summarization, in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

A system receives a request to generate a summary report (e.g., “target summary report”) from a set of base reports (Operation 202). In one or more embodiments, this request may originate from managerial or supervisory personnel within the organizational hierarchy seeking a summary report of specific operational aspects. For example, a department head may request a summary report encompassing the project milestones, team performance metrics, and identified errors within their department. In another example, an executive overseeing multiple departments may seek a comprehensive summary that consolidates key insights from various base reports. In one or more embodiments, the request may take the form of a digital query submitted through a user interface designed for managerial interactions, where the user can specify parameters such as, for example, the timeframe, relevant departments, or specific metrics of interest. Additionally, the request might include contextual details about the purpose of the summary report, indicating whether it is intended for, e.g., a higher-level executive review, a departmental assessment, or any other organizational context.

In one or more embodiments, the report may be scheduled to be generated at regular intervals without any specific request. For example, the report may instead be automatically generated based on detecting a threshold number of sub-reports that have been previously completed and stored. In another example, the system may automatically generate weekly or monthly summary reports including key performance indicators, trends, and notable changes within the organization. In some instances, multiple automated reports may be tailored differently to specific hierarchies with varying scopes of responsibility.

The system determines if a set of target base data exists for the request (Operation 204). For example, the system may identify a request for a summary report for a particular project. The system accesses a set of data stored in a data repository to determine whether a requisite set of base reports exists that are required to execute the request. The system may also determine whether a set of additional raw data exists. For example, the system may determine whether a set of customer work order logs has been updated. In addition, or in the alternative, the system may determine whether a set of system performance metrics exists. If the system determines that a set of target base data exists for the request, then the system proceeds to apply an ML model to the set of base reports to select subsets of data components for inclusion in the target summary report, which will be described further below (Operation 210).

Conversely, if the system determines that a set of target base data does not exist for the request, then the system proceeds to identify required data needed to access target base data (Operation 206). For example, the system may determine that a team of employees has not generated or stored a set of base reports required to generate the summary report. In addition, or in the alternative, the system may determine that an application has not executed a process that would generate system performance data to be included in the report.

The system generates a set of base data (Operation 208). For example, the system may generate a notification to a set of employees to generate a set of progress reports. Upon determining that the employees have generated and stored the reports, the system accesses the stored reports. As another example, the system may run a debugging process to generate a debugging report for a software project. The system may access the debugging report for identifying information to include in a summary report. In one or more embodiments, the system performs one or more data preprocessing tasks on base reports and raw data, such as, e.g., cleaning, formatting, and validating information included in the base reports and raw data.

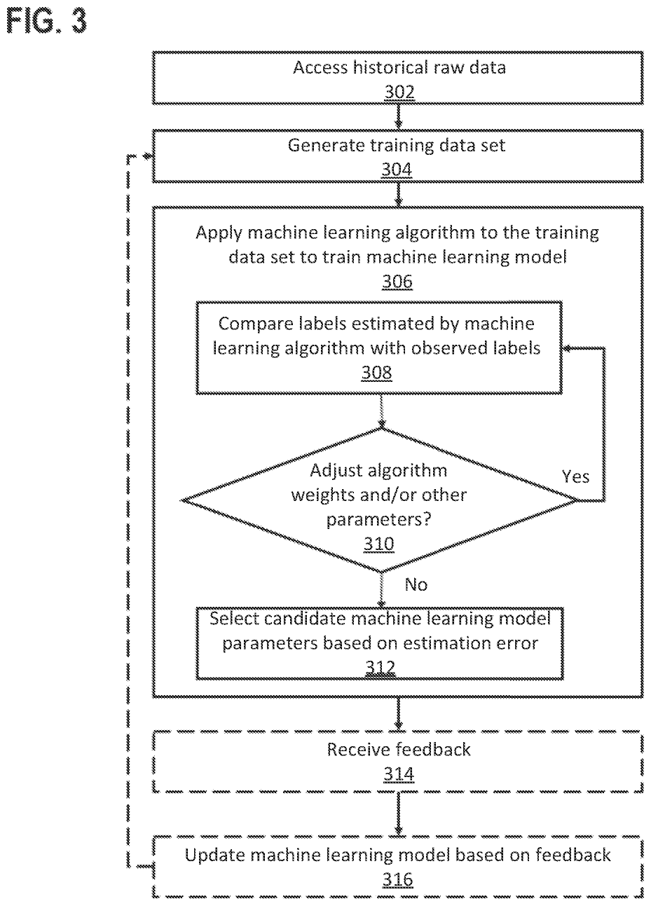

The system applies a trained ML model to the set of base reports to select subsets of data components for inclusion in the target summary report (Operation 210). An illustration of ML model training according to some embodiments is described below with respect to FIG. 3.

In one or more embodiments, the set of base reports includes multiple base reports generated at different times. The set of base reports generated at different times includes multiple values corresponding to a particular data component at those different times. The machine learning model identifies the multiple values across the multiple base reports. Selecting data components for inclusion in the summary report includes selecting at least one performance metric based on the multiple values corresponding to the data component at different times.

In one or more embodiments, the subsets of data components for inclusion in the summary report includes data components from a set of base reports generated at various intervals. For example, the base reports may be generated daily, weekly, or monthly. These base reports may include a variety of data components that reflect, e.g., the status, progress, or outcomes of tasks or objectives over time. The method includes the extraction and analysis of these data components to ascertain performance metrics. The performance metrics could involve calculations, such as trend analyses, averages, variances, or any other statistical measure that offers insight into the performance of individuals, groups, projects, or the organization as a whole. In one or more embodiments, determining at least one performance metric is executed by assessing the values of a specific data component pulled from several base reports, each associated with a distinct time interval. In one or more embodiments, performance metrics derived from temporal data in base reports could be selected for inclusion in the summary report. The data components selected may represent various formats, including, for example, tables, charts, graphs, or narrative descriptions.

In one or more embodiments, the ML model is trained to identify patterns among a set of values of the subset of data components selected for inclusion in the set of base reports. These patterns may be indicative of trends, anomalies, or critical metrics that may be utilized to understand the organizational performance or the status of specific operations. Base reports at a low hierarchal level may contain granular data, such as a particular task performed by a particular employee in a given week. The base report for one employee may not include the data needed to identify trends or metrics across multiple base reports. The trained ML model detects relevant patterns within the granular data that should be included in summary reports associated with higher hierarchal levels. The patterns recognized by the model might include sequential occurrences, correlations between different data components, or repeated instances of specific values. For example, the ML model may identify from a set of two or more base reports generated at different times a description of a particular system slowdown. In one report, the employee generating the report may write the following: “The system performed optimally Monday through Thursday. The system crashed on Friday. I restored the system and it operated normally thereafter . . . .” In another report the following month, the employee may write the following: “The system performed normally on Monday, but crashed on Tuesday. I restored the system and it operated normally for the rest of the week . . . .” The ML model learns to identify the system crashes as being part of a pattern. For example, the ML model may identify a set of features that are correlated to the crashes, such as executing a particular application or set of applications, high processor consumption, or high levels of requests to access a set of data. The system may generate the summary report by (a) identifying the pattern (e.g., system crashes at particular times), and (b) identifying the features that may have contributed to the pattern. For example, the summary report may include the following: “Employee A reported a system crash on 11/1. Employee B reported a system crash on 11/15. Employee A reported another system crash on 11/19. In each instance, a tenant attempted to initiate Application B while Application A was already running.”

Applying the ML model involves processing the information contained in base reports that may vary widely in content, structure, and format, depending on their origin within an organizational hierarchy. These reports may include, but are not limited to, daily summaries, weekly overviews, technical logs, or any other periodic documentation created to track tasks, accomplishments, challenges, or statuses relevant to the operations of individuals or groups within an organization.

The trained model may utilize techniques such as pattern recognition, natural language processing, and entity recognition. The model analyzes each report to identify information to include in summary reports. During this process, the model identifies common themes, high-priority issues, significant achievements, and key performance indicators that are of particular interest to entities associated with higher hierarchal levels. It determines these elements by referencing patterns and rules for inclusion that it has learned during its training phase that may involve, for example, an understanding of context, the significance of certain keywords, the frequency of issues, and correlations among reported items.

Based on its analysis of the base reports, the ML model identifies a subset of data components from the based reports to include in the summary reports at higher hierarchal levels. For example, the model may aggregate individual accomplishments from multiple reports into summary statistics that reflect team performance over a particular period.

In one or more embodiments, the ML model reduces the volume of data components from the set of base reports by a specified amount or percentage. For example, the ML model may identify one hundred different data components in a base report. The system may train the ML model to identify no more than 10 percent of the data components to be included in summary reports at a higher hierarchal level. The ML model may reduce the volume of data based on learned attribute of the data during training, such as the frequency of occurrence of certain data items, the historical importance of data types based on past management feedback, and the representation of trends or outlier conditions that merit special attention. For instance, the model may be trained to identify and prioritize data components related to high-severity issues or items reflecting significant deviation from expected norms.

In one or more embodiments, the specified amount or percentage the volume of data is reduced by may be adjusted based on user feedback, temporal constraints, or organizational requirements. Such customization allows for flexibility in report generation, ensuring the end product aligns with user expectations and situational demands. In one or more embodiments, the system applies a feedback loop to retrain the ML model. The system obtains feedback regarding the effectiveness of previous summaries to set parameters specifying the volume reduction strategy for subsequent summary reports. In one or more embodiments, the feedback includes previously created summary reports or other historical data. This historical analysis may assist the ML model in learning, via the training process, managerial preferences, common reporting themes, and key performance indicators that are relevant to the second level of the hierarchy.

In one or more embodiments, a set of base reports with data components selected for inclusion in a summary report correspond to a level in an organizational hierarchy. The set of base reports originate from a lower tier within an organizational structure than a tier associated with the summary report. For example, the set of base reports may originate at the individual contributor or team level, where granular details and a large volume of data components may represent, for example, daily activities, tasks completed, or challenges faced.

In one or more embodiments, the ML model applied within this context is trained to recognize the distinctions and priorities of different hierarchical levels. Accordingly, the ML model selects different data components from a set of base reports for inclusion in different summary reports associated with different hierarchal levels.

In one or more embodiments, the ML model identifies a data component in a base report that is associated with a particular text description. The system identifies, by the ML model, another data component in a different base report associated with a different text description from the initial text description. The system then classifies these data components with a data component identification label and selects them for inclusion in the summary report. For instance, within the context of a software development organizational hierarchy, the ML model may identify a data component in a base report associated with individual bug reports detailing errors identified in the software development process. The ML model identifies another data component in another base report with a different text description, such as a description related to the status of project milestones in the development lifecycle. The ML model classifies both data components with a specific data component identification label, signifying their relevance to each other within the context of a software development process. The ML model selects these labeled data components for inclusion in the summary report.

In one or more embodiments, an ML model is trained and utilized to distill and organize data from base reports for inclusion in more condensed and informative summary reports. In one or more embodiments, the machine learning model identifies key data components within the base reports that are a collection of detailed accounts likely to contain varied descriptive text associated with specific data points. For instance, one base report may contain a description of a particular event, issue, or metric articulated in one way, while another report may describe a related event, issue, or metric in a different manner or using different terminology. In one or more embodies, an ML model may generate embeddings of different terms and cluster them together. The system identifies the same component, but describes this component differently based on its clustering. For example, the ML model may identify the same component referred to in different base reports as a “software bug” and a “coding error”. When clustering these embeddings, the model can identify that these terms refer to the same data component.

In one or more embodiments, a neural network-based model may similarly identify the same component, but describe this component differently based on an iterative training process. For example, the model may encounter the same data component in different base reports referred to as “customer feedback” and “client reviews”, within the same context of evaluating product performance. Through an iterative training process, the neural network refines its understanding of these components and learns to recognize the underlying equivalence between the two terms.

In one or more embodiments, the ML model recognizes that despite the differences in text descriptions, the two data components are related and pertain to similar underlying concepts or categories. This recognition is facilitated by the model's ability to process natural language and identify the semantic and contextual cues that suggest a relationship between seemingly disparate data points. Upon detecting such connections, the model can assign a common data component identification label to both the data components, effectively tagging them as related items that should be considered together or understood to refer to the same matter.

In one or more embodiments, the system generates one embedding representing one data component in a base document and another embedding representing another data component. Based on a similarity between two embeddings, the system clusters these embeddings in a same cluster associated with a particular data component identification label. For example, one data component may describe a performance metric of a set of software developers using a particular term. Another data component may describe the performance metric of a different set of software developers using another term. If these two embeddings are determined to be substantially similar, the system clusters the embeddings together. For example, the embeddings may be within a threshold distance of each other in an n-dimensional space, where the n dimensions correspond to a number of features in the embeddings.

In one or more embodiments, the system identifies data storage information associated with a data component selected by the ML model for inclusion in the summary report. Generating the summary report includes generating a digital link to a data storage location indicated by the data storage information. When the ML model selects data components for inclusion in the summary report, it also identifies related data storage information that is associated with these selected components. The data storage information could be, for example, a database identifier, a unique resource locator (“URL”), or any other identifier that allows for locating the original source of the data. Such data storage information enables detailed review and analysis, for it provides a direct pathway to the underlying data that may not be fully captured by the summary alone.

In one or more embodiments, the system applies a generative artificial intelligence (AI) model to the prompt to select data components for inclusion in a summary report. The system generates a prompt that includes a subset of data components determined to be relevant for inclusion in a summary report. The selection of the data components is based on the output of an ML model that has been trained to assess base reports and identify the data components that are most useful and relevant to the needs of higher organizational hierarchy levels. In one or more embodiments, the generative AI model takes the prompt derived from the selected data components and transforms it into a comprehensive narrative that makes the data more comprehensible for human users. The generative AI model operates by utilizing techniques, such as deep learning, to construct a coherent summary report that captures the essence of the information within the data components.

In one or more embodiments, the prompts generated for the AI model are particularly structured to ensure that the resulting text adheres to organizational standards for reporting. This structure may include elements such as adherence to specific terminology, formatting preferences, or the degree of detail required by the intended audience.

In one or more embodiments, the system generates trend information from the subset of data components selected from a set of base reports. The trend information corresponds to selected time periods and provides a historical overview or analytical insight into how particular data components have changed or evolved over these time periods. The selected time periods could be predefined (such as daily, weekly, monthly, quarterly, annually, etc.), or they may be custom periods defined by the user or the system based on the context of the reporting need.

In one or more embodiments, the process of generating trend information may involve computational techniques, including statistical analyses, regression models, time-series analyses, or ML algorithms. The extracted trends could be visually represented in the summary reports through various forms of data visualization, such as graphs, charts, or heat maps to enable easy interpretation by end-users. The machine-readable media may further include instructions for portraying trend information graphically.

In one or more embodiments, the system calculates one or more performance metrics based on the subset of data components. These performance metrics serve as quantitative measures of certain aspects of organizational performance and can be derived from the data figures, statistics, or status information contained in the subset of data components. Examples of such metrics may include, but are not limited to, productivity rates, error rates, resolution times, customer satisfaction scores, compliance indicators, or financial performance, such as return on investment or cost savings. The trend information may include, for example, an increase or decrease in the frequency of certain events, variations in quantitative measurements, or changes in qualitative status indicators. The calculated performance metrics are selected to be relevant to the objectives of the summary report and provide an objective basis for assessing performance in areas determined to be most critical by the organizational hierarchy requesting the report. The system may utilize algorithms to transform the raw data accessed from the base reports into these performance metrics. This calculation may involve aggregating data from multiple base reports, applying statistical analysis functions, or performing time series analyses to determine trends over the reporting period. The specific computational methods utilized for metric calculation are tailored to the nature of the underlying data and the context of the summary report.

In one or more embodiments, once the performance metrics have been calculated, the system includes a representation of the metrics in the summary report. For example, the performance metrics may be displayed as part of dashboards, graphs, or numerical values with appropriate annotations or explanatory text. Additionally, these metrics could be highlighted or detailed further through drill-down features, enabling users to access the data underlying the metrics in a more granular fashion when needed.

In one or more embodiments, the performance metrics serve as a reflection of past and current performance and can also be utilized in predictive analytics within the organization. By utilizing these calculated metrics, forecasting models can project future performance trends based on past data. This predictive aspect empowers managers and executives to make more informed strategic decisions. The system ensures that these predictive analytics are also conveyed in a user-friendly manner, making data analysis concepts accessible to non-technical stakeholders.

In one or more embodiments, the performance metrics are used to predict future organizational performance over a selected future time period. For example, the system may apply a prediction-type machine learning model to a set of measured or calculated performance metrics to predict future values for the metrics. These performance metrics could be calculated based on numerous factors that may include, but are not limited to, historical data trends, completion rates of tasks, frequency and types of reported challenges, and the rate of accomplishments as documented in the base reports. The predictive model may be trained using historical data to establish baselines and patterns that can be indicative of future outcomes.

In one or more embodiments, the system predicts future values for performance metrics based on a variety of indicators. The performance metrics used for predictions can include quantitative data, such as sales figures, defect rates, customer satisfaction scores, and delivery times. These quantitative measures are bolstered by qualitative insights gleaned from textual analysis of the reports that could include sentiment analysis, topic clustering, and identification of key themes or issues being repeatedly addressed.

In one or more embodiments, the ML model for prediction takes into account temporal patterns by analyzing the performance metrics over designated future time periods. These time periods could be short-term (e.g., weeks or months) or long-term (e.g., quarters or years) depending on the needs and goals of the organization. The future time periods are designated based on various factors such as the typical business cycles, industry standards, or strategic planning calendars of the organization.

The system generates a target summary report (Operation 212). The system includes the selected subsets of data components within the summary report.

In one or more embodiments, generating the summary report includes producing a natural language description of identified patterns. This description is intended to translate the raw data and patterns into a form that is more accessible and interpretable by human readers. For example, the system may apply report content to a language model, such as a large language model (LLM), to generate a natural language report. The system may utilize this language model to provide a human-readable, contextually rich description of the data components for the natural language report. In one or more embodiments, the system may train this language model on large sets of linguistic corpora to generate a natural language report that is coherent and human-comprehensible.

In one or more embodiments, generating a summary report includes generating a single new digital document using data from a set of multiple base digital documents. The system generates the new digital document by applying a set of software algorithms that are designed to format, organize, and present selected data components in a specified manner. For example, the system may generate executive summaries, bullet points, graphs, charts, or other visual aids to effectively summarize the selected data. The system may generate different data display elements based on the data being displayed. For example, the system may identify one subset of data components from one base report to be displayed with a set of bullet points. The system may identify another subset of data components from a set of multiple base reports to be included in an executive summary describing an overall productivity of a team.

In one or more embodiments, the system generates a digital link, such as a hyperlink, that references the data storage location indicated by the data storage information. This digital link is integrated into the summary report. When users are reviewing the summary report, they can interact with the digital links to access stored data linked to the report.

In one or more embodiments, the generation of the summary report includes maintaining confidentiality and privacy by anonymizing or redacting sensitive information. This process systematically scans the selected data components for the presence of individual names or specific customer data. Upon detecting such information, the system either obscures the identifying portions of the text (e.g., through anonymization techniques such as pseudonymization) or entirely removes the specifics to prevent inadvertent disclosure of confidential information.

In one or more embodiments, the anonymization process executed by the system is rule-based, utilizing predefined guidelines that account for various types of sensitive information that might appear in the reports. These rules dictate the portions of the data that should be anonymized or redacted and ensure consistent application across all reports generated. For example, customer names might be replaced with unique identifiers or completely redacted to prevent any possibility of re-identification from the report contents. The system may leverage ML techniques to improve its ability to identify and process sensitive data by learning from corrections and feedback provided by users over time.

In one or more embodiments, the system integrates one or more entity recognition algorithms that specifically locate personal identifiers and potentially sensitive data. These could include, but are not limited to, names, addresses, account numbers, or any unique customer identifiers. Upon identification, the entity recognition system enables the redaction or replacement of this information with generic placeholders or category labels prior to the generation of the summary report.

In one or more embodiments, the system may offer varying levels of anonymization or redaction based on user privileges or the intended audience of the summary report. For example, a summary report intended for higher-level management may contain more detailed information, including partially redacted identifiers, while a report designated for wider distribution may undergo comprehensive redaction to anonymize potentially identifiable information. The customization of privacy levels respects both the need for information within the organization and the obligation to protect sensitive personal and customer data.

In one or more embodiments, the system displays a summary report on a user interface with interactive elements to drill down into underlying data. This includes a user interface feature designed to enhance the accessibility and utility of the summary report for end-users. This user interface is equipped with interactive elements that allow the user to navigate to and view various details that underlie the data components aggregated and presented in the summary. The interactive elements may include, but are not limited to, buttons, hyperlinks, drop-down menus, or other graphical user interface widgets that when activated by the user provide access to more detailed information or source data from where the summary was derived. In one or more embodiments, the detailed information made accessible through the interactive elements can include the original individual reports, annotations, comments, or raw data related to specific data components.

In one or more embodiments, the user interface may incorporate data visualization tools, such as charts, graphs, or heat maps, so users can visualize the data underlying the summary report. For example, if the summary report includes performance metrics, the user may be able to click on a particular metric to see a trend graph or a breakdown of contributing factors.

In one or more embodiments, the system provides a user interface for one or more individual managers to customize the summarization and prioritization for one or more additional summary reports. This is specifically designed to empower managers with the ability to tailor the summarization and prioritization processes to their unique preferences or to adhere to organizational reporting guidelines. The user interface may present a variety of customizable options that can be accessed through a simplified dashboard or a set of control panels. These options enable managers to establish rules or criteria for selecting the data components that should be included in the summary reports. The interface may also allow for the setting of thresholds, weights, and other parameters that influence the ML model's selection mechanisms, ensuring that managers retain a level of direct control over the content of the reports.

In one or more embodiments, the interactive user interface may provide a visual representation of base reports and their components alongside tools to manually select or deselect specific data elements for inclusion in the summary reports. Managers could use drag-and-drop functionality or other selection methods to mark items deemed critical or irrelevant to their reporting objectives. By making these selections, managers can provide real-time training data to the ML model that can learn to adapt the reporting process based on the input provided.

In one or more embodiments, this user interface may include a feedback mechanism where managers can review the ML model's selections and provide approvals or rejections. These responses would be cataloged and utilized to adjust the model's future selection patterns. Through iterative feedback and learning, the model would become more accurate in predicting the types of data components that meet the manager's criteria for inclusion in the summary reports. The user interface may also feature an activity log or decision history, enabling managers to track changes made to the selection criteria and understand how their inputs have influenced the summarization outcomes.

In one or more embodiments, the system may also support customization features that enable group-based or hierarchical reporting. For instance, different levels of management could have distinct interfaces or profiles within the system, allowing for layer-specific report customization that respects the organizational structure. This approach provides a means for ensuring that the content and context of summary reports are appropriate for their intended audiences, whether for operational teams or executive leadership. Additionally, the customization features could extend to the presentation of the summary reports, enabling managers to define templates, styles, and formatting preferences that align with company branding or departmental requirements.

In one or more embodiments, a user interface may be provided to allow organizational managers or analysts to interact with the predictive aspects of the system. This interface can offer tools for scenario planning, where users can adjust the inputs and assumptions to see how they might affect future performance predictions. Furthermore, the interface could provide visualizations of the predicted performance metrics across different time frames, thereby enabling decision-makers to validate and refine their strategic direction with the aid of predictive insights.

In one or more embodiments, the summary report is periodically updated based on new individual reports and modifications to the integrated data sources. These updates integrate new individual reports and reflect modifications to integrated data sources. This ensures that the summary report remains current and accurate over time. The periodic nature of the updates can be established according to a predefined schedule, such as daily, weekly, monthly, or quarterly, or may be triggered by certain events, such as the receipt of a new individual report or changes to data within the integrated sources.

In one or more embodiments, the updating mechanism may utilize one or more algorithms to determine the relevance and impact of the new data on the summary report. For instance, the system may analyze the content of the new individual reports in comparison to previous reports to determine changes, trends, or deviations. Simultaneously, alterations in the integrated data sources can trigger re-evaluations of relevant data that ensure the summarized information in the summary report accurately reflects the current state of the data.

In one or more embodiments, the instructions stored on the machine-readable media may direct the processors to execute operations that merge new data with the existing content of the summary report. In one or more embodiments, the merging process includes reapplying the ML model to the combined datasets to refine selection and summarization of data components.

In one or more embodiments, the update process may further include a validation or approval step, where the updated summary report is reviewed before being finalized. This review could be automated using additional ML algorithms to verify accuracy or could involve human oversight, particularly in cases where strategic decisions or sensitive information might be inferred from the report. Upon validation, the newly updated summary report becomes accessible to end-users, stakeholders or the intended audience.

### 4. Machine Learning Model Training

FIG. 3 illustrates an example set of operations for training a machine learning model to provide ML-augmented report summarization, in accordance with one or more embodiments. One or more operations illustrated in FIG. 3 may be modified, rearranged, or omitted altogether. Accordingly, the particular sequence of operations illustrated in FIG. 3 should not be construed as limiting the scope of one or more embodiments.

In some embodiments, a system (e.g., one or more components of system 100 illustrated in FIG. 1) accesses historical raw data (Operation 302). Accessing this historical raw data may include extracting information from base reports and one or more external data sources.

The system utilizes the historical data related to report summarization to generate a set of training data (Operation 304). This training data encompasses various labels associated with different aspects of report summarization. For example, labels may include relevance scores for base report data, accuracy assessments of identified patterns within reports, and effectiveness comparisons between machine-generated summaries compared to human-generated summaries.

According to one embodiment, the system accesses the historical data and the training data set from a repository storing labeled data sets specific to report summarization. The training data set may be curated by entities involved in report summarization. Alternatively, the training data set may be generated and maintained by a third party. According to one embodiment, the system generates the labeled data by parsing documents and generating labels based on parsed values in the documents. According to an alternative embodiment, one or more users generate labels for a data set.

In some embodiments, generating the training data set includes generating a set of feature vectors for the labeled examples. A feature vector for an example may be n-dimensional, where n represents the number of features in the vector. The number of features that are selected may vary depending on the particular implementation. The features may be curated in a supervised approach or automatically selected from extracted attributes during model training and/or tuning. Example features may include information about the types of reports, data components present in the reports, the frequency of specific terms or phrases, and the structural characteristics of the reports. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if a type of summary report has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 306). For example, the machine learning algorithm may analyze the training data set to train neurons of a neural network with particular weights and offsets to refine understanding of which relevant information to include during the summarization process. The particular modification recommendation labels may include identifying data components, determining an optimal summary length, and recognizing contextual cues for effective summarization.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the system may generate and train a candidate recurrent neural network model, such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one expense or activity may depend on its position within a sequence of feature vector representations. Thus, the nodes may have a memory to remember relevant temporal dependencies between different feature vectors. For example, if the system is summarizing reports related to financial data, the model may automatically learn to prioritize certain financial indicators based on the historical order and significance of those indicators in the summarization process.

In some embodiments, the system compares the labels estimated through the one or more iterations of the machine learning model algorithm with observed labels to determine an estimation error (Operation 308). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error (Operation 310). Adjustments may be made until a candidate model that minimizes the estimation error or otherwise achieves a threshold level of estimation error is identified. The process may return to Operation 308 to make adjustments and continue training the machine learning model.

In some embodiments, the system selects machine learning model parameters based on the estimation error meeting a threshold accuracy level (Operation 312). For example, the system may select a set of parameter values for a machine learning model based on determining that the trained model has an accuracy level of at least 98% for summarizing reports effectively.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of related ML-augmented report summarization tasks. Each summarization task may be processed as a separate discrete instance of time. For example, an example may include reports related to different organizational aspects, and each report is processed separately at different time points. Backpropagation through time may perform adjustments through gradient descent starting at the latest time point and moving backward in time, considering the historical order and importance of features in the summarization process. Further, the backpropagation process may adjust the memory parameters of a cell such that a cell remembers dependencies between different aspects of the summarization process. For instance, if the summarization process involves understanding trends over time, the memory may capture the relationships between historical summaries, allowing the model to adapt to changing patterns in the reports. Additionally, or alternatively, the system may train other types of machine learning models tailored to ML-augmented report summarization.

Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of summary reports.

In embodiments in which the machine learning algorithm is a supervised machine learning algorithm, the system may optionally receive feedback on the various aspects of the analysis described above (Operation 314). For example, the feedback may affirm or revise labels generated by the machine learning model. For example, the machine learning model may initially classify a set of text as corresponding to a second-tier summary report. The feedback may classify the set of text as corresponding instead to a third-tier summary report, and not to the second-tier summary report. Alternatively, the feedback may classify the set of text for exclusion from any summary report. Based on the feedback, the machine learning training set may be updated, thereby improving its analytical accuracy (Operation 316). Once updated, the system may further train the machine learning model by optionally applying the model to additional training data sets.

One or more embodiments use a large language model (LLM) to generate summary reports. LLMs are a type of deep learning model which combines a deep learning technique called attention in combination with a deep learning model type known as transformers to build predictive models. These predictive models encode and predict natural language writing.

LLMs contain hundreds of billions of parameters trained on multiple terabytes of text. LLMs are trained to receive natural language as an input. LLMs typically generate natural language as an output. In addition, some LLMs may be trained to output computer code, visual output (such as images), and audio output. LLMs are made up of layers of attention mechanisms and neural networks that process input data in parallel. The layers of attention mechanisms and neural networks operating in parallel allow the LLM to learn complex patterns in text.

The attention mechanisms help neural networks to learn the context of words in the sequences of words. An attention mechanism operates by breaking down a set of input data, such as a sentence or sequence of words or tokens, into keys, queries, and values. Keys represent elements of the input data that provide information about what to pay attention to. Queries represent elements of the input data that need to be compared with the keys to determine relevance. Values are elements of the input data that will be selected or weighted based on the attention scores. The attention mechanism calculates a similarity score between each query and key pair. This score reflects how relevant each key is to a given query. Various methods can be used to compute these scores, such as dot-product, scaled dot-product, or other custom functions. The similarity scores are then transformed into attention weights. For example, a system may transform the similarity scores using a softmax function. The softmax function adjusts the values of the similarity scores relative to each other such that the sum of the similarity scores is 1. Finally, the attention weights are used to take a weighted sum of the corresponding values. This weighted sum represents the model's focused or “attended” representation of the input data. In one or more embodiments, the attention mechanisms are implemented using self-attention processes, scaled dot-product attention processes, and multi-head attention processes.

In operation, the LLM receives a natural language prompt as input data and generates a sequence of words in natural language by predicting a next word, or sequence of words, based on the textual and grammatical patterns learned by the LLM during training. In one or more embodiments, the system provides the LLM with a prompt including subsets of data components—such as words, phrases, and sentences—identified by a machine learning model for inclusion in a summary report.

In the context of report summarization, the LLM is provided with an input prompt containing subsets of data components identified by an ML model. The LLM generates the report content from the subsets of data. The LLM uses its training to determine linguistic structures and semantic associations to generate natural language summaries that reflect the information contained in the subsets of data components. In one or more embodiments, the LLM tailors the language and style to align with a desired tone and comprehensibility of the summary report. In one or more embodiments, the LLM constructs a coherent narrative that encapsulates, e.g., key insights from the identified data components.

### 5. Example Embodiment for Generating a Summary Report Using a Machine Learning Model

A detailed example is described below for purposes of clarity. Components and/or operations described below should be understood as one specific example that may not be applicable to certain embodiments. Accordingly, components and/or operations described below should not be construed as limiting the scope of any of the claims.

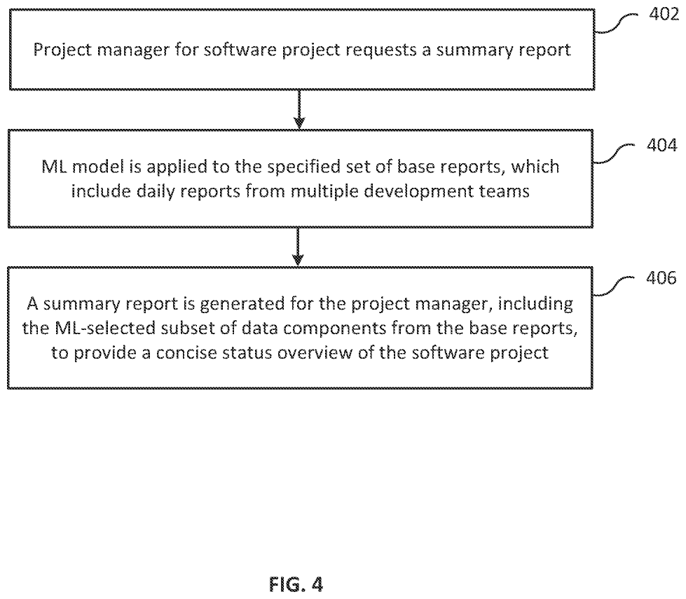

FIG. 4 illustrates an example embodiment for generating a summary report using an ML model, in accordance with some embodiments. This example embodiment relates to ML-augmented report summarization.

A project manager for a software product project submits a request for a summary report (Operation 402). The project manager selects an icon on a graphical user interface (GUI) that generates instructions in a project management system. The icon may include text “Project Gamma Weekly Report.” Based on the selection, the system identifies a set of base reports that are required to generate the selected report. The set of base reports includes a set of daily reports generated by software development teams detailing various aspects of their work, such as bug fixes, code updates, and project progress.

The system determines if the set of base reports exist. The system queries a database for the set of base reports identified in the request.

If the reports don't exist, the project management platform sends a notification to users associated with the base reports to generate the base reports. For example, the system may generate an email or instant message to a set of computer programmers that “Manager has requested the weekly report. Please complete your status update.” In addition, the system can generate a notification to a user to perform an action that will generate a set of data. For example, the system may direct a user to run a testing program on a set of software to generate a set of results. The results may be included in the user's base report.

Upon obtaining the required base reports, the system applies a trained ML model to the set of base reports to identify content to include in the summary report (Operation 404). The ML model analyzes the data components within the base reports and selects relevant information by using its learned patterns and associations from training the ML model. In the example embodiment, at least one base report details a user's progress on a set of project milestones. The base report includes data components related to completion percentages and timelines. For example, the user estimates they have completed 60% of a particular task. The user further indicates that due to a software bug the task may not be completed on schedule. The user may estimate a delay of three days to complete the task, compared to a project timeline.

In addition to generating a notification for a set of users to generate a set of base reports, the system further accesses a set of stored, previously-generated base reports. These base reports include information related to financial metrics and operational efficiency. For example, one base report contains time-series data illustrating monthly sales figures, production output, and resource utilization. The system processes these time-series type base reports to generate trend-type performance data, identifying patterns and fluctuations over time. This includes extracting information related to seasonal variations in sales, peak production periods, and resource optimization trends. For example, in the context of resource optimization trends, the system may analyze previously-generated base reports to identify and extract patterns related to workforce utilization and productivity. The patterns may relate to peak hours of employee activity or recurring bottlenecks in the workflow.

In addition to extracting data from base reports, the system identifies a set of raw data, not included in the base reports, to include in the summary report. This includes parsing additional data sources, such as external data sources. For example, the system may access market trends from industry reports and extract information about market fluctuations, consumer preferences, and emerging technologies. For example, in the context of the software development project, the system may extract information from an industry report describing the need for the type of application that is being developed. For example, an industry report may describe the need for applications that enable human resource departments to make use of artificial intelligence to perform certain functions. The system may identify an excerpt from the industry report for inclusion in a summary report describing a software development project to develop a platform that enables companies to make use of artificial intelligence to perform certain functions. The system may access industry benchmarks from reputable sources and extract key performance indicators relevant to the organization's sector. The system may additionally incorporate customer feedback by accessing and analyzing online reviews, customer surveys, and social media sentiments.

The system generates the summary report based on (a) content included in the set of base reports, (b) the raw data, and (c) the additional data from external sources, such as the industry report (Operation 406). The report includes the selected subset of data components without incorporating non-selected data components from the base reports. The summary report includes a concise overview of daily achievements, highlighting trends, performance metrics, and relevant details for efficient managerial decision-making.

The system applies an LLM-type ML model to the selected content to generate a natural language summary report. The system processes the selected content and generates a human-readable natural language summary report that includes relevant information from the base reports, raw data, and the set of time-series type base reports. The resulting summary report encapsulates key findings, such as performance metrics for different departments over time, resource optimization trends, and market trends, in a human-readable manner. It also provides key insights into workforce productivity, areas for improvements in resource allocation, and outlines shifts in market dynamics.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

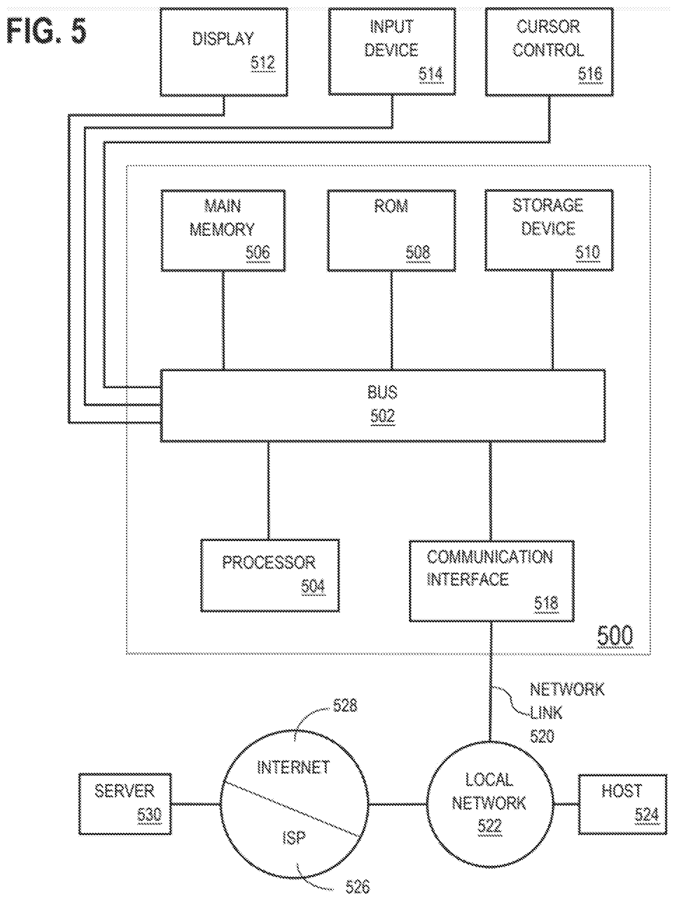

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer entity. An input device 514, including alphanumeric and other keys, is coupled to bus 502 for communicating information and command selections to processor 504. Another type of entity input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518 that carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory machine-readable media storing instructions which, when executed by one or more processors, cause performance of operations comprising:
training a machine learning model to select data components in base reports for inclusion in summary reports, the training comprising:
accessing training data sets, each training data set comprising:
a particular base report comprising a particular set of data components; and
an identification of a subset of the particular set of data components, comprised in the particular base report, that are to be included in a particular summary report associated with the particular base report; and
training the machine learning model based on the training data sets;
receiving a request to generate a first target summary report from a first set of base reports, the first set of base reports comprising one or more base reports;
applying the machine learning model to the first set of base reports to select a first subset of data components from the first set of base reports to include in the first target summary report; and
generating the first target summary report to include the selected, first subset of data components from the first set of base reports without including a non-selected, second subset of data components from the first set of base reports.

2. The one or more non-transitory machine-readable media of claim 1, wherein the particular base report and the first set of base reports correspond to a first level in an organizational hierarchy,
wherein the particular summary report and the first target summary report correspond to a second level in the organizational hierarchy that differs from the first level.

3. The one of more non-transitory machine-readable media of claim 2, wherein the request identifies the second level in the organizational hierarchy, and
wherein the machine learning model selects the first subset of data components based at least on a relationship between the first subset of data components and the second level in the organizational hierarchy.

4. The one or more non-transitory machine-readable media of claim 2, wherein the operations further comprise:
receiving a second request to generate a second target summary report from a second set of base reports, the second set of base reports including at least the first target summary report;
applying the machine learning model to the second set of base reports to select a third subset of data components from the second set of base reports to include in the second target summary report; and
generating the second target summary report to include the selected, third subset of data components from the second set of base reports without including a non-selected, fourth subset of data components from the second set of base reports.

5. The one or more non-transitory machine-readable media of claim 1, wherein the operations further comprise:
identifying, by the machine learning model, a first data component in a first base report among the first set of base reports, the first data component associated with a first text description;
identifying, by the machine learning model, a second data component in a second base report among the first set of base reports, the second data component associated with a second text description different from the first text description;
classifying the first data component and the second data component with a first data component identification label; and
based on classifying the first data component and the second data component with the first data component identification label: selecting, by the machine learning model, the first data component and the second data component for inclusion in the first target summary report.

6. The one or more non-transitory machine-readable media of claim 5, wherein the operations further comprise:
generating a first embedding representing the first data component;
generating a second embedding representing the second data component;
based on a similarity between the first embedding and the second embedding: clustering the first embedding and the second embedding in a first cluster associated with the first data component identification label.

7. The one or more non-transitory machine-readable media of claim 1, wherein the operations further comprise:
identifying data storage information associated with a first data component selected, by the machine learning model, for inclusion in the first target summary report,
wherein generating the first target summary report comprises generating a digital link to a data storage location indicated by the data storage information.

8. A method comprising:
training a machine learning model to select data components in base reports for inclusion in summary reports, the training comprising:
accessing training data sets, each training data set comprising:
a particular base report comprising a particular set of data components; and
an identification of a subset of the particular set of data components, comprised in the particular base report, that are to be included in a particular summary report associated with the particular base report; and
training the machine learning model based on the training data sets;
receiving a request to generate a first target summary report from a first set of base reports, the first set of base reports comprising one or more base reports;
applying the machine learning model to the first set of base reports to select a first subset of data components from the first set of base reports to include in the first target summary report; and
generating the first target summary report to include the selected, first subset of data components from the first set of base reports without including a non-selected, second subset of data components from the first set of base reports.

9. The method of claim 8, wherein the first set of base reports comprises a plurality of base reports generated at different times and including a plurality of values corresponding to a first data component at the different times,
wherein generating the first target summary report using the first subset of data components comprises:
determining at least one performance metric based on the plurality of values corresponding to the first data component at different times; and
including the at least one performance metric in the first target summary report.

10. The method of claim 8, wherein applying the machine learning model to the first set of base reports to select a first subset of data components from the first set of base reports to include in the first target summary report comprises: identifying a pattern among a set of values of the first subset of data components in the set of base reports, and
wherein generating the first target summary report comprises: generating a natural language description of the pattern.

11. The method of claim 8, wherein generating the first target summary report comprises:
generating a prompt including the first subset of data components; and
applying a generative artificial intelligence (AI) machine learning model to the prompt to generate the first target summary report.

12. The method of claim 8, further comprising:
generating trend information over selected time periods from the first subset of data components.

13. The method of claim 8, wherein generating the first target summary report comprises:
anonymizing or redacting sensitive information by removing individual names or specific customer data.

14. The method of claim 8, further comprising:
displaying the first target summary report on a user interface with interactive elements to drill down into underlying data.

15. A system comprising:
one or more processors; and
memory storing instructions that, when executed by the one or more processors, cause the system to perform:
training a machine learning model to select data components in base reports for inclusion in summary reports, the training comprising:
accessing training data sets, each training data set comprising:
a particular base report comprising a particular set of data components;
and
an identification of a subset of the particular set of data components, comprised in the particular base report, that are to be included in a particular summary report associated with the particular base report; and
training the machine learning model based on the training data sets;
receiving a request to generate a first target summary report from a first set of base reports, the first set of base reports comprising one or more base reports;
applying the machine learning model to the first set of base reports to select a first subset of data components from the first set of base reports to include in the first target summary report; and
generating the first target summary report to include the selected, first subset of data components from the first set of base reports without including a non-selected, second subset of data components from the first set of base reports.

16. The system of claim 15, wherein the first target summary report is periodically updated based on new individual reports and modifications to the integrated data sources.

17. The system of claim 15, wherein the machine learning model reduces the volume of data components from the first set of base reports by a specified amount or percentage.

18. The system of claim 15, wherein the instructions further cause the system to perform:
providing a user interface for one or more individual managers to customize the summarization and prioritization for one or more additional target summary reports.

19. The system of claim 15, wherein the instructions further cause the system to perform:
calculating one or more performance metrics from the first subset of data components.

20. The system of claim 15, wherein the performance metrics are used to predict future organizational performance over a selected future time period.
